(19) United States
(12) Patent Application Publication
(10) Pub. No.: US 2026/0061460 A1
(43) Pub. Date: Mar. 5, 2026

(54) Screen device

(71) Applicant: Kleemann GmbH, Göppingen (DE)

(72) Inventor: Florian Nägele, Hüttisheim (DE)

(21) Appl. No.: 19/289,447

(22) Filed: Aug. 4, 2025

(30) Foreign Application Priority Data
Aug. 29, 2024 (DE) 10 2024 124 712.6

(51) Int. Cl. B07B 1/34; B07B 1/42; B07B 1/46

(52) U.S. Cl. CPC B07B 1/34; B07B 1/42; B07B 1/4609

(57) ABSTRACT

A screen device having a screen tray which can be vibrated by a vibratory drive having two exciter units mechanically intercoupled by a synchronization device. A sheathing tube extends between two lateral screen panels. At least one of the exciter units has a motor housing mounted in an aperture of one of the lateral screen panels. The sheathing tube has a sheathing tube holder disposed in the area of the inside of the lateral screen panel which sheathing tube holder has at least one fit mount. A fastening element having a securing section is pressed into the fit mount non-rotatably and in an axially immovable manner. A stud of the fastening element is guided through apertures in the lateral screen panel and a fastening flange of the motor housing to connect the motor housing to the lateral screen panel.

### RELATED APPLICATION

The present application claims priority to German Patent Appl. Ser. No. DE 10 2024 124 712.6 filed Aug. 29, 2024, which is incorporated herein by reference.

### BACKGROUND OF THE DISCLOSURE

### Field of the Disclosure

The disclosure relates to a screen device having a screen tray, in or on which at least one screen lining is disposed in a screening area between two lateral screen panels disposed spaced apart from each other, wherein the screen tray can be vibrated by means of a vibratory drive, wherein the vibratory drive has two exciter units, wherein the exciter units are mechanically intercoupled by means of a synchronization device, wherein a sheathing tube extends in the area between the two lateral screen panels, inside which tube the synchronization device is accommodated at least sectionally, and wherein at least one of the exciter units has a motor unit having a motor housing, and the motor housing is mounted in an aperture or in the area of an aperture of one of the lateral screen panels.

Such screen devices are used to screen and size mineral screening material. They can be used in particular as pre-screen devices or as post-screen devices, preferably in material processing devices for processing, in particular for the comminution, of mineral materials. Accordingly, the screen device can be disposed in the direction of the material flow of the material processing device upstream or downstream of the crushing device.

### Description of the Prior Art

Screen devices are known from the state of the art, which have two exciter units in the form of imbalance drives (“flange vibration motors”), flanged laterally to the screen tray. To synchronize the imbalance of the left and right sides, the exciter units are interconnected for co-rotation by a shaft. The shaft is encompassed by a jacket tube to protect it from dirt and contact. For assembly, an imbalance drive first has to be inserted at one end. The imbalance drive is then fitted at the opposite end. The imbalance drives are installed by two people simultaneously from the inside and outside of the lateral screen panel.

### SUMMARY OF THE DISCLOSURE

The disclosure addresses the problem of providing a screen device of the type mentioned above, which makes for a simple assembly and maintenance of the vibratory drive.

This problem is solved in that the sheathing tube has a sheathing tube holder, in particular a flange, in the area of at least one lateral screen panel, which sheathing tube holder is disposed in the area of the inside of the lateral screen panel and which sheathing tube holder has at least one fit mount, wherein a fastening element having a securing section is pressed into the fit mount non-rotatably and in an axially immovable manner, and wherein a stud of the fastening element is guided through apertures or fastener openings in the lateral screen panel and a fastening flange of the motor housing to connect the motor housing to the lateral screen panel.

The sheathing tube can be installed in the screen tray for mounting the vibratory drive. The fastening element(s), which are part of the sheathing tube, are inserted through aligned apertures in the lateral screen panel and the motor housing. This is easy to do as the fastening elements are firmly and captively connected to the sheathing tube holder. The sheathing tube is then held in a pre-assembly position between the lateral screen panels. The technician can now easily complete the installation from the outside of the screen tray by fitting suitable securing elements, such as nuts, to the fastening elements.

If maintenance is required, the exciter unit can also be easily replaced if the fastening element is first inserted through an aperture in the lateral screen panel and then through an aperture in the motor housing when viewed from the inside of the screen tray. The motor housing can then be removed, wherein the sheathing tube can remain installed in the screen tray and does not have to be disassembled.

Overall, the disclosure offers a particularly easy-to-install and easy-to-maintain design to the user.

According to a variant of the disclosure, provision may be made for the fastening element to have a head, which adjoins the securing section and for the head to rest on the end of the fastening piece, in particular the flange, facing away from the lateral screen panel. This results in a form-fit support of the fastening element in the axial direction of the fastening element. Thus, the motor housing and the sheathing tube can be securely fastened at the same time.

A preferred variant of the disclosure provides for the stud of the fastening element to have a threaded section at its free end, onto which a nut is screwed, which clamps the motor housing to the lateral screen panel. This ensures the reliable attachment of the motor housing to the lateral screen panel, wherein installation can be easily performed in the area outside of the lateral screen panel.

The fastening element can be easily mounted on the sheathing tube holder if provision is made for the securing section to have a surface structure having elevations and depressions on its outer circumference, and for the elevations to be pressed into the inner circumference of the fit mount, which is designed as a drilled hole, such that a form-fit connection is established between the securing section and the fit mount in the circumferential direction of the securing section.

A possible variant of the disclosure can be such that the motor housing accommodates an electric motor, which drives a drive shaft, wherein both ends of the drive shaft are routed out of the motor housing at opposite ends, that the drive shaft has mounts in the area of its ends, to each of which mounts an imbalance weight is attached, and that the motor housing is inserted into the aperture in the lateral screen panel. Because the motor housing is inserted into the aperture, a load distribution relieving the securing section of the fastening element in a favorable manner in relation to stress is achieved. As a result, the connection between the securing section and the sheathing tube holder is subjected to little or no bending stress. To this end, provision may particularly be made for a sectional plane to extend perpendicular to the axis of rotation of the drive shaft to intersect the securing section of the fastening element and the electric motor and/or for the drive shaft to be mounted by means of two bearings, which are fastened to bearing holders of the motor housing, and for the securing section of the fastening element to be disposed between the two bearings in the direction of the axis of rotation of the drive shaft.

A screen device according to the disclosure can be such that the sheathing tube has two tube sections, which can be telescoped relative to each other in the direction of the axis of rotation of the drive shaft of the motor unit, and that the tube sections each bear a flange at their end assigned to the assigned lateral screen panel and are connected to the assigned lateral screen panel by means of fastening elements. The sheathing tube can therefore first be compressed for installation in the screen tray and then telescoped outwards in the installation position.

Assembly is particularly easy if provision is made, in a pre-assembly position of the sheathing tube, for the distance in the direction of the longitudinal extent of the sheathing tube from the free end of the fastening element connected to the first flange to the free end of the fastening element connected to the second flange to be smaller than the clear distance between the lateral screen panels in this direction, and for this distance between the free ends of the fastening elements in the assembly position to be greater than the clear distance between the lateral screen panels, such that the free ends project beyond the exterior of the lateral screen panels. In the pre-assembly position, the sheathing tube can therefore be easily inserted into the screen tray. In the installation position, the fastening elements hold the sheathing tube in a form-fitting manner in the direction of gravity such that the sheathing tube can then be easily connected to the lateral screen panel from the outside, for instance screwed.

A conceivable variant of the disclosure can be such that the tube sections are telescopically inserted into each other in such a way that the outer circumference of the first tube section rests against the inner circumference of the second tube section to form a sliding guide in the direction of the longitudinal extent of the sheathing tube, and that preferably provision is made for the tube sections to be rotatable relative to each other in the circumferential direction. This considerably facilitates assembly. In addition, the adjacent circumferential areas seal the interior of the sheathing tube from the surroundings, at least sectionally.

For optimum vibration behavior of the vibratory drive, provision may be made for the exciter units to be mechanically coupled to each other by means of a synchronization device, wherein the synchronization device has two transmission elements, which are releasably coupled in the area of a coupling point by means of a coupling device and are intercoupled for co-rotation.

For the purpose of further improved assembly or maintenance of the vibratory drive, provision may be made for an orientation aid having at least one orientation element, which is disposed and designed to orient the transmission elements with respect to each other in the area of the coupling point during the joining process of the two transmission elements, to be provided. This means that the transmission element(s) can be oriented in an assembly position by means of the at least one orientation element during the joining motion to enable the transmission elements to be joined, preferably without access to the coupling point from the outside. This considerably facilitates assembly. This also reduces the number of parts required.

To compensate for any positional tolerances of the two exciter units, provision may be made for the coupling device to have a cardan shaft, in which the transmission elements have tube sections having non-circular cross-sections, which are inserted into each other, for each tube section to bear a universal joint each, and for the universal joints to each be connected to a drive shaft by means of a coupling piece.

### BRIEF DESCRIPTION OF THE DRAWINGS

The disclosure is explained in greater detail below based on an exemplary embodiment shown in the drawings. In the figures,

FIG. 1 is a side view of a schematic representation of a screen device in vertical section,

FIG. 2 shows a vibratory drive of the screen device as shown in FIG. 1, along the sectional line marked II-II in FIG. 1,

FIG. 3 shows a detail of the vibratory drive along the sectional line marked III-III in FIG. 1,

FIG. 4 shows a detailed representation along the sectional line marked IV-IV in FIG. 2.

FIG. 5 shows a perspective view of a fastening element,

FIG. 6 shows a side view of a synchronization device and

FIG. 7 shows the synchronization device along the sectional line marked VII-VII in FIG. 6.

### DETAILED DESCRIPTION

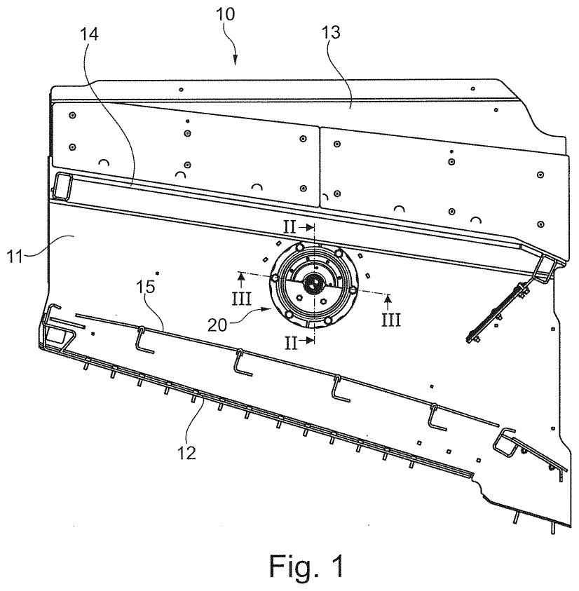

FIG. 1 shows a screen device as it is typically used in a material processing device, in particular in a rock crusher. The screen device has a screen tray 10. This screen tray 10 has two spaced-apart lateral screen panels 11, between which a screen area is formed.

At the bottom end, the screen tray 20 is closed by a bottom 12. At least one screen lining 14, 15 is disposed inside the screen tray 10 spaced apart from the bottom 12. In this exemplary embodiment, two screen bottoms 14, 15 are installed.

A conveying area 13 is formed in the area above the upper screen lining 14. During operation, the screen tray 10 is vibrated by means of a vibratory drive 20. As a result of these vibrating motions, screenings deposited on the upper screen lining 14 are conveyed along the conveying area 13, from left to right in FIG. 1. A first partial fraction is screened on the screen lining 14 and transported away via the screen lining 14. The screened material falls onto the lower screen lining 15 and is subjected to a further screening process. The screened material is transported away again on the lower screen lining 15 and the fine fractions that have fallen through the screen lining 15 are discharged via the bottom 12.

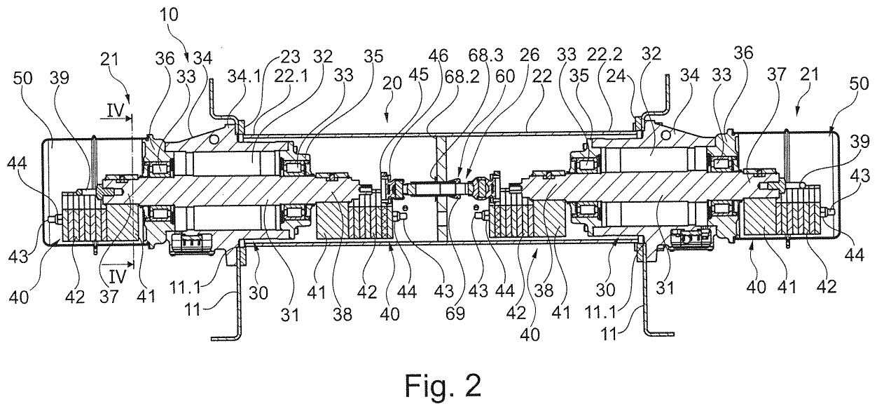

The vibratory drive 20 is illustrated in more detail in FIG. 2. As this illustration shows, the vibratory drive 20 has a modular design and has two exciter units 21. Each exciter unit 21 is attached in the area of a lateral screen panel 11. The two exciter units 21 are intercoupled via a synchronization device 26 which may also be referred to as a synchronizer 26.

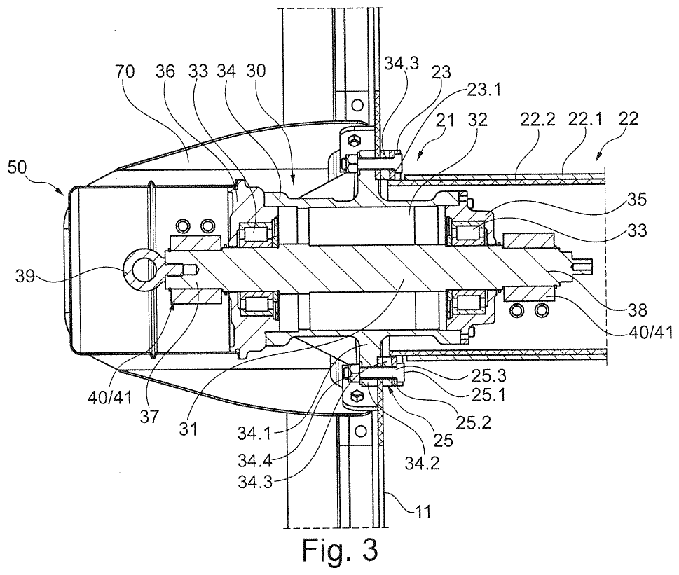

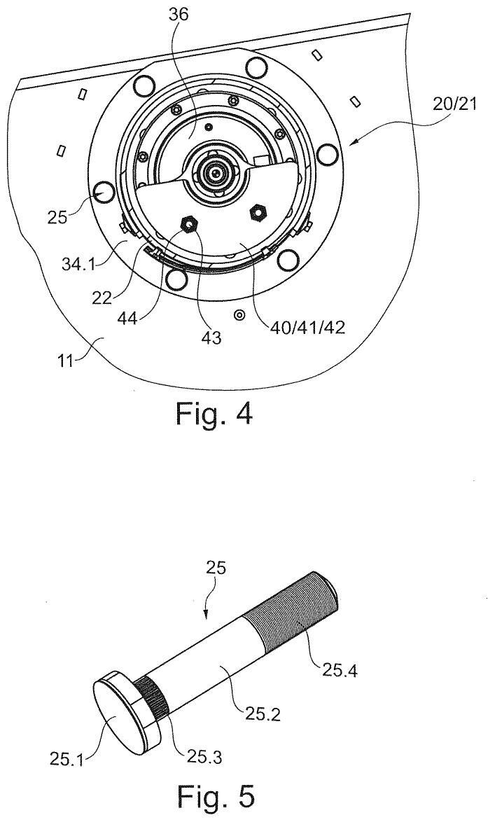

With reference to FIG. 3, first the structure of the exciter units 21 is explained in more detail. As this illustration shows, the exciter unit 21 can be designed such that it generates an imbalance by means of one or more imbalance weights 40, which are disposed eccentrically to a drive shaft 31. This imbalance generates the vibrations in the screen tray 10.

The exciter unit 21 can have a motor unit 30, which comprises the drive shaft 31. The drive shaft 31 is driven by the motor rotor of an electric motor 32. The drive shaft 31 is rotatably mounted on opposite ends of the electric motor 32 by means of bearings 33. The electric motor 32 is housed in a motor housing 34. The bearings 33 may be mounted in the motor housing 34 itself. However, it is also conceivable, as shown in FIG. 3, that separate bearing holders 35, 36 are attached to the motor housing 34, in each of which one of the bearings 33 is mounted. This allows for a modular design to be implemented, in which the prefabricated bearing holders 35, 36 can be installed from a kit having different motor housings 34.

A fastening flange 34.1 can be provided for fastening the motor unit 30 to the screen tray 10, which in particular can be integrally connected to the motor housing 34.

The motor unit 30 can preferably be fastened in an opening 11.1 in the lateral screen panel 11. The motor housing 34 can be inserted into this aperture 11.1. Holes are drilled in the lateral screen panel 11 to secure the motor unit 30. These drilled holes are aligned with holes 34.2 of the mounting flange 34.1. The motor unit 30 is fastened to the lateral screen panel 11 by means of fastening elements 25, which are inserted through the aligned drilled holes 34.2 in the lateral screen panel 11 and in the fastening flange 34.1, as will be explained in more detail below.

As further illustrated in FIG. 3, the drive shaft 31 may have a mount 37, 38 each at each of its two ends. An imbalance weight 40 is attached to each of these mounts 37, 38 for co-rotation. The imbalance weight 40 has an individual weight 41. This individual weight 41 has a drilled hole. The individual weight 41 is pushed onto the mount 37, 38 of the drive shaft 31 by means of this drilled hole.

As FIG. 2 shows, it may now be necessary to use an additional imbalance mass, depending on the system configuration. For this purpose, provision may be made, in addition to the individual weight 41, for one or more additional weights 42 to be connected directly or indirectly to the drive shaft 31 at one or both ends of the drive shaft 31 for co-rotation.

As FIG. 2 shows, the additional weight 42 can be directly connected to the individual weight 41. For this purpose, provision may be made for the individual weight 41 to be provided with a stud bolt 43, onto which a drilled hole of the additional weight 42 is pushed. This allows the additional weight 42 to be connected to the individual weight 41 by screwing a nut 44 onto the stud bolt 43, which nut securely clamps the additional weight 42 to the individual weight 41.

Preferably, the masses at both ends of the drive shaft 31 are equal or at least approximately equal to achieve an even load on the drive shaft 31.

FIG. 3 shows that the motor unit 30 can be equipped with a support device, preferably a lifting eye 39. The lifting eye 39 may be screwed into the outer end of the drive shaft 31 in the area of the mount 37. The support device can be used to attach the motor unit 31 to an auxiliary device and to handle it more easily for assembly purposes to simplify assembly.

As FIG. 2 shows, the two exciter units 21 on both ends of the screen tray 10 can be constructed similarly in principle, such that reference can be made to the above explanations. Preferably, the exciter units 21 are identical or essentially identical in design, to reduce the number of parts and assembly work.

In the area of the outside of the assigned lateral screen panel 11, a cover 50 is used to cover the exciter units 21, which cover is preferably connected to the assigned bearing holder 36. The cover 50 covers the rotating parts of the motor unit 30 on the outside precluding any risk of injury there.

FIG. 1 and FIG. 3 further illustrate that the part of the motor unit 30 projecting on the outside beyond the lateral screen panel 11 can be completely or at least largely covered by a protective cover 70 at the top in the direction of gravity. This protective cover 70 protects the motor unit 30 from the mechanical impact of falling parts. The protective cover 70 can be manufactured from a sheet steel blank as a stamped and bent part.

FIGS. 2 and 3 show that a sheathing tube 22 extends between the two lateral screen panels 11. The sheathing tube 22 has two tube sections 22.1, 22.2, which are pushed into each other. The tube sections 22.1, 22.2 of the sheathing tube 22 each have a flange 23, 24 at their end facing the lateral screen panel 11. The flanges 23, 24 are equipped with fit mounts 23.1 shaped like drilled holes (see FIG. 3).

To fasten the sheathing tube 22 between the lateral screen panels 11, the two tube sections 22.1, 22.2 are pushed into each other until the tube ends abut the flanges 23, 24. The length of the sheathing tube 22 is then smaller than the clear distance between the lateral screen panels 11. The sheathing tube 22 can thus easily be brought into the area between the lateral screen panels 11.

The fastening elements 25 already mentioned above are used to fasten the sheathing tube 22 to the lateral screen panels 11. The fastening elements 25 are designed as fit studs and are shown more clearly in FIG. 5.

As FIG. 5 shows, the fastening elements 25 have a head 25.1. This head 25.1 is integrally connected to a stud 25.2. A securing section 25.3 is formed on the stud 25.2 in the transition area between the head 25.1 and the stud 25.2. This securing section 25.3 has a surface structure having elevations and depressions. Opposite from the head 25.1, the fastening element has a threaded section 25.4.

The fastening elements 25 can be inserted stud 25 first through the fit mount 23.1 of the flange 23. In the assembled state, the securing section 25.3 comes to rest in the fit mount 23.1. The fit mount 23.1 is designed as a drilled hole, wherein the diameter of the drilled hole is smaller than the outer diameter of the securing section 25.3. Thus, the securing section 25.3 can be pressed into the fit mount 23.1, wherein the aforementioned protrusions of the securing section 25.3 dig into the inner panel of the fit mount 23.1. In this way, the securing section 25.3 forms a form-fit connection of the flange 23 and the fastening element 25 in the circumferential direction of the stud 25.2.

FIG. 3 illustrates that the stud 25.2 of the fastening elements 25 is inserted through a drilled hole in the lateral screen panel 11 and through the drilled hole 34.2 of the fastening flange 34.1 of the motor housing 34. A nut 34.4 is screwed onto the threaded section 25.4 of the fastening element 25. Thus, the fastening elements 25 can be used to connect the motor housing 34 and at the same time the assigned tube section 22.1, 22.2 to the lateral screen panel 11.

Installation is extremely simple. As mentioned above, the sheathing tube 22 only has to be placed between the two lateral screen panels 11. The two tube sections 22.1, 22.2 can be telescoped into each other to such an extent that the clear dimension between the lateral screen panels 11 is greater than the distance between the free ends of the studs 25.2 of the fastening elements 25, which are pre-mounted and fastened in the two flanges 23, 24 in the fit mounts 23.1. If the studs 25.2 are aligned with the drilled holes in the lateral screen panels 11, the tube sections 22.1, 22.2 only have to be moved outwards for the threaded sections 25.4 to be inserted through the lateral screen panels 11. The sheathing tube 22 is thus held in a pre-assembly position. Access from the inside of the screen tray 10 is then no longer required for further assembly. The assembly steps below can be performed from the outside of the screen tray 10.

In particular, the two motor units 30 can now be attached to the lateral screen panels 11 from the outside and the nuts 34.4 tightened on the outside. Because the securing section 25.3 of the fastening element 25 is held captive and non-rotatable in the flange 23, 24, the fastening element 25 no longer has to be held by the inside of the screen tray 10 when the nut 34.4 is tightened. When the nut 34.4 is tightened, the two tube sections 22.1, 22.2 are telescoped further outwards such that they can compensate for any positional tolerances of the lateral screen panels 11.

Provision may be made for sealing elements 34.3 to be disposed between the flanges 23, 24 to prevent dust from entering the area encompassed by the sheathing tube 22. The sealing element 34.3 can, for instance, be designed as a circumferential sealing ring, which is disposed between the flange 23, 24 and the inside of the lateral screen panel 11.

The two exciter units 21 are mechanically intercoupled by means of a synchronization device 26, as shown in FIG. 2. The synchronization device 26 is used to synchronize the rotary motions of the drive shafts 31 of the motor units 30.

As FIG. 2 shows, the synchronization device 26 holds the centers of gravity of the imbalance weights 40 of the exciter units 21 at identical angular positions or at least approximately at identical angular positions in the circumferential direction.

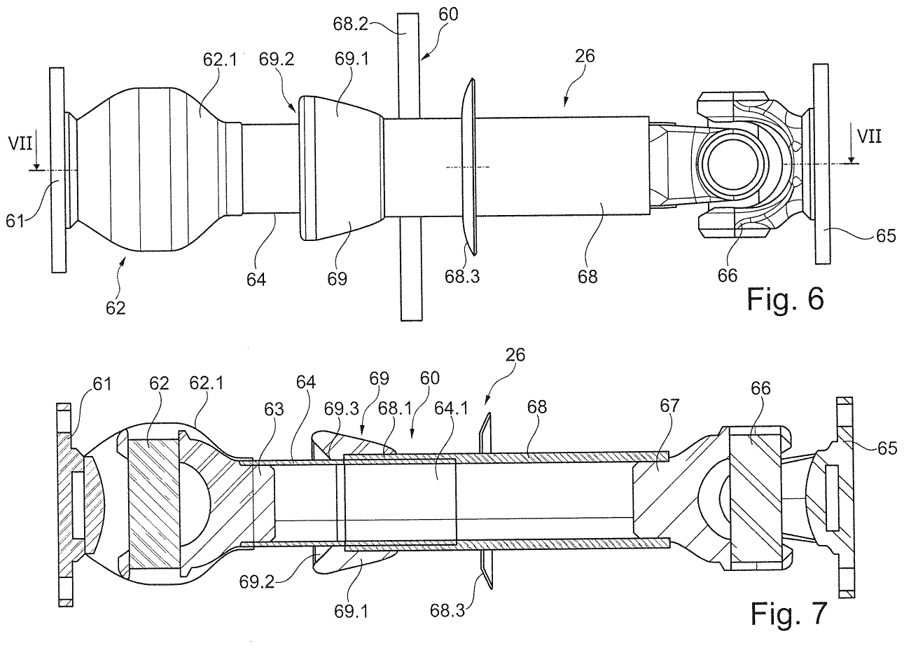

The synchronization device 26 may comprise a coupling device 60 as shown in FIGS. 6 and 7. The coupling device 60 may have coupling pieces 61, 65 at opposite ends, each of which is connected to one of the drive shafts 31 of the motor units 30 for co-rotation, as FIG. 2 shows.

For this purpose, a holder 45 can be connected to the drive shaft 31 for co-rotation. The assigned end of the coupling device 60 is connected to this holder 45 by means of screw connections 46

A universal joint 62 is connected to each of the coupling pieces 61. The universal joint 62 bears a transmission element 64 and the universal joint 66 bears a transmission element 68. The two transmission elements 64 and 68 can be interconnected, in particular for co-rotation.

The two transmission elements 64, 68 may be or have tube sections 64.1, 68.1. The tube sections 64.1, 68.1 may have a non-circular cross-section and are pushed into each other in the area of a coupling point which may also be referred to as a coupling zone, as FIG. 7 shows. The cross-sections of the tube sections 64.1, 68.1 in the joining area of the coupling point are designed such that they form a form-fit connection in the circumferential direction when joined.

As shown in FIG. 7, the universal joints 62, 66 may have fastening pieces 63, 67, which are fitted into the ends of the tube sections 64.1, 68.1 facing away from the coupling point to form a connection between the universal joint 62, 66 and the tube section 64.1, 68.1 for co-rotation.

As shown in FIGS. 6 and 7, an orientation aid is used which is designed and disposed to orient at least one of the transmission elements 64, 68 in its mounting position during the joining motion during which the exciter unit 21 is mounted on the lateral screen panel 11. This oriented assembly position should be such that the two transmission elements 64, 68 are joined without the need for an operator to access the coupling point.

Preferably, the sheathing tube 22 is closed in the area of the coupling point, which significantly simplifies its design. Alternatively, provision may also be made for only an inspection opening to be incorporated into the sheathing tube 22 in the area of the coupling point to monitor the joining process and correct it if necessary.

The orientation aid has at least one orientation element 62.1, 68.2, 69.

The individual orientation elements 62.1, 68.2, 69 are explained in more detail below. As shown in FIGS. 6 and 7, the orientation element 62.1 may be formed and disposed to stabilize one of the universal joints 62, 66 in the mounting position or at least approximately in the mounting position.

For this purpose, provision may be made for the orientation element 62.1 to be designed in the form of an elastic component, which braces one of the universal joints 62, 66 such that the transmission element 64, 68 connected to the joint is held in a joining position raised relative to the direction of gravity.

As the illustrations show, the orientation element 62.1 may be formed by a plastic shrink tube, which encompasses the universal joint 62, 66. The shrink tube holds the transmission element 64 in its raised orientation relative to the direction of gravity, as shown in FIGS. 6 and 7, or at least approximately in the position shown.

Additionally or alternatively, the orientation aid can also have an orientation element 68.2, as shown in FIG. 6. This orientation element 68.2 can preferably be formed by a molded body which is pushed onto the outer circumference of one of the transmission elements 64, 68. FIG. 2 shows that the outer circumference of this orientation element 68.2 is supported on the inner contour of the sheathing tube 22. It can be supported on the inner panel of the sheathing tube 22 along the entire circumference or only along part of the circumference. In this way, the connected transmission element 68 is oriented in its mounting position or approximately in its mounting position relative to the stationary sheathing tube 22.

The transmission element 68 may also bear a limiting element 68.3. As FIG. 7 shows, the latter can be integrally connected to the transmission element 68. The limiting element 68.3 is used to limit the displacement motion of the orientation element 68.2 attached to the transmission element 68.

Additionally or alternatively, provision may be made for an orientation element 69 to be used, which is attached to one end of a transmission element 64, 68 by means of an attachment section 69.1. The mounting motion of the orientation element 69 on the transmission element 64, 68 is limited by a stop 69.3 of the orientation element 69.

For instance, this stop 69.3 may strike the free end of the transmission element 68, to which the orientation element 69 is attached. The orientation element 69 has a centering mount 69.2, which is orientated towards the second transmission element 64. This centering mount 69.2 can be designed in the form of a funnel-shaped extension, as shown in FIG. 7.

To mount the exciter units 21, one of the exciter units 21 is first mounted on the assigned lateral screen panel 11 as described above. The transmission element 64, 68 connected to this exciter unit 21 is inserted into the sheathing tube 22. If the orientation aid is such that the orientation element 62.1, which braces the universal joint 62, is used, the transmission element 64 is already oriented in its approximate mounting position.

If the orientation element 68.2 is used, the connected transmission element 68 is centered relative to the sheathing tube 22 in its approximate mounting position.

When the two exciter units 21 are now moved towards each other, the free end of the transmission element 64 penetrates into the centering mount 69.2 of the orientation element 69 and is oriented such that the two transmission elements 64, 68 can be fitted into each other, as shown in FIG. 7.

If the non-circular cross-sections of the transmission elements 64, 68 do not match exactly, this can be corrected by slightly twisting one of the exciter units 21 until there is an exact match and the transmission elements 64, 68 can finally be inserted into each other.

Finally, the fastening elements 25 can be used to clamp the exciter units 21 to the lateral screen panel 11 as explained above and the assembly is complete.

1-13. (canceled)

14: A screen device, comprising:
a screen tray including two lateral screen panels spaced apart to form a screening area;
at least one screen lining disposed in the screening area;
a vibratory drive configured to vibrate the screen lining, the vibratory drive including first and second exciter units, at least one of the exciter units including a motor housing mounted on of one of the screen panels, the motor housing including a fastening flange;
a synchronizer mechanically intercoupling the first and second exciter units;
a sheathing tube extending between the two lateral screen panels, the synchronizer being at least partially received in the sheathing tube, the sheathing tube including a sheathing tube holder adjacent the one of the screen panels, the sheathing tube holder having at least one fit mount defined through the sheathing tube holder; and
a fastening element including a securing section press fit into the fit mount of the sheathing tube holder non-rotatably and in an axially immovable manner, the fastening element further including a stud guided through a fastener opening of the one of the lateral screen panels and a fastener opening of the fastening flange of the motor housing to connect the motor housing to the one of the lateral screen panels.

15: The screen device of claim 14, wherein:
the fastening element further includes a head adjoining the securing section, wherein the head rests on an end of the sheathing tube holder facing away from the one of the lateral screen panels.

16: The screen device of claim 14, wherein:
the stud of the fastening element includes a threaded section at a free end of the stud; and
the fastening element further includes a nut screwed onto the threaded section to clamp the motor housing to the one of the lateral screen panels.

17: The screen device of claim 14, wherein:
the fit mount of the sheathing tube holder is a drilled hole having an inner circumference; and
the securing section of the fastening element includes a surface structure having elevations and depressions on an outer circumference of the surface structure, the elevations being press fit into the inner circumference of the fit mount such that a form-fit connection is established between the securing section and the fit mount.

18: The screen device of claim 14, wherein:
the motor housing contains an electric motor which drives a drive shaft, opposite ends of the drive shaft extending out of the motor housing at opposite ends of the motor housing, wherein imbalance weights are attached to each of the opposite ends of the drive shaft.

19: The screen device of claim 18, wherein:
a sectional plane extending perpendicular to an axis of rotation of the drive shaft intersects the securing section of the fastening element and the electric motor.

20: The screen device of claim 18, wherein:
the drive shaft is mounted in two bearings fastened to bearing holders of the motor housing; and
the securing section of the fastening element is disposed between the two bearings in a direction of an axis of rotation of the drive shaft.

21: The screen device of claim 14, wherein:
the sheathing tube includes two tube sections which can be telescoped relative to each other in a direction of an axis of rotation of the synchronizer, the two tube sections each including one of the sheathing tube holders in the form of a tube flange at their ends adjacent to respective ones of the screen panels; and
each of the tube flanges is connected to the respective one of the screen panels by a plurality of the fastening elements.

22: The screen device of claim 21, wherein:
the two tube sections can be telescoped relative to each other between a pre-assembly position and an assembly position;
in the pre-assembly position a distance in a direction of a longitudinal extent of the sheathing tube from a free end of the fastening elements connected to the tube flange of one of the tube sections to a free end of the fastening elements connected to the tube flange of the other of the tube sections is smaller than a clear spacing between the lateral screen panels; and
in the assembly position the distance in the direction of the longitudinal extent of the sheathing tube from the free end of the fastening elements connected to the flange of one of the tube sections to the free end of the fastening elements connected to the flange of the other of the tube sections is greater than the clear spacing between the lateral screen panels such that the free ends of the fastening elements project beyond an exterior of each of the lateral screen panels.

23: The screen device of claim 21, wherein:
the two tube sections are telescoping inserted one into the other such that an outer circumference of one of the tube sections rests against an inner circumference of the other of the tube sections to form a sliding guide in the direction of a longitudinal extent of the sheathing tube; and
the tube sections are rotatable relative to each other in a circumferential direction.

24: The screen device of claim 14, wherein:
the synchronizer includes two transmission elements releasably coupled together for co-rotation.

25: The screen device of claim 24, further comprising:
an orientation aid including at least one orientation element configured to orient the transmission elements with respect to each other during a process of joining the two transmission elements.

26: The screen device of claim 25, wherein:
the two transmission elements include two tube sections having non-circular cross-sections, one tube section being inserted into the other tube section;
each tube section has a universal joint attached to the tube section, so that the tube sections and the universal joints form a cardan shaft; and
each of the universal joints is connected to a drive shaft of an electric motor of a respective one of the first and second exciter units.

27: A method of assembling a vibratory drive of a screen device, the screen device including a screen tray including two lateral screen panels spaced apart to form a screening area, at least one screen lining disposed in the screening area, and the vibratory drive configured to vibrate the screen lining, the vibratory drive including first and second exciter units, each of the exciter units including a motor housing mounted on of one of the screen panels, the motor housings each including a fastening flange, and a synchronizer mechanically intercoupling the first and second exciter units, the method comprising:
extending a sheathing tube between the two lateral screen panels, the synchronizer being at least partially received in the sheathing tube, the sheathing tube including two tube sections telescopingly received one in the other, each tube section including a sheathing tube holder adjacent the one of the screen panels, each of the sheathing tube holders having a plurality of fit mounts defined through the sheathing tube holder; and
press fitting a plurality of fastening elements each including a securing section into the fit mounts of each of the sheathing tube holders non-rotatably and in an axially immovable manner, the fastening elements each further including a stud guided through a fastener opening of the one of the lateral screen panels and a fastener opening of the fastening flange of one of the motor housings to connect the motor housings to the lateral screen panels.

28: The method of claim 27, further comprising:
telescoping the two tube sections relative to each other into a pre-assembly position in which a distance in a direction of a longitudinal extent of the sheathing tube from a free end of the fastening elements connected to the sheathing tube holder of one of the tube sections to a free end of the fastening elements connected to the sheathing tube holder of the other of the tube sections is smaller than a clear spacing between the lateral screen panels; and
wherein the extending further includes extending the tube sections into an assembly position wherein the distance in the direction of the longitudinal extent of the sheathing tube from the free end of the fastening elements connected to the flange of one of the tube sections to the free end of the fastening elements connected to the flange of the other of the tube sections is greater than the clear spacing between the lateral screen panels such that the free ends of the fastening elements project beyond an exterior of each of the lateral screen panels.

29: The method of claim 28, further comprising:
screwing a nut onto a threaded section of the free end of each of the fastening elements to clamp the motor housings to the lateral screen panels.
